(19) United States
(12) Patent Application Publication
(10) Pub. No.: US 2008/0049950 A1
(43) Pub. Date: Feb. 28, 2008

(54) Nonlinear Processor for Audio Signals

(76) Inventor: Mark Allstair Poletti, Wellington (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/843,523

(22) Filed: Aug. 22, 2007

(30) Foreign Application Priority Data
Aug. 22, 2006 (NZ) 549382

(51) Int. Cl. H04B 15/00

(52) U.S. Cl. 381/94.2

(57) ABSTRACT

A nonlinear processor for distorting audio signals having an input stage (15) that is arranged to split an audio input signal (13) into two signal paths and then a pair of asymmetric distortion stages (17, 19), one in each signal path, with non-equal negative and positive saturation limits, so as to produce opposite polarity mean signal levels at their outputs in each signal path, and which produce a smooth transition from linear to nonlinear behaviour. Following the asymmetric distortion stages (17, 19) is a pair of AC-coupled symmetric distortion stages (21, 23), one in each signal path, and an output stage (25) that is arranged to add the two nonlinearly distorted signals from the symmetric distortion stages to generate an audio output signal (27) that demonstrates a smooth transition from linear behaviour to the production of crossover-like artifacts.

### FIELD OF THE INVENTION

The present invention relates to a nonlinear processor for musical signals that are generated by electronic instruments such as guitars and keyboards and musical signals from recorded acoustic instruments. More particularly, although not exclusively, the invention relates to the distortion of electric guitar signals to produce musically desirable sounds.

### BACKGROUND TO THE INVENTION

The sound of the electric guitar is significantly dependent on the properties of the guitar amplifier. Guitar amplifiers typically have a non-flat frequency response aimed to enhance the sound of the guitar signal, such as by compensating for the guitar pickups or providing enhanced high frequencies for other subjective reasons. In addition, guitar amplifiers often operate in a highly nonlinear manner, distorting the guitar signal to produce harmonics and intermodulation frequency components which provides increased sustain and a more interesting and complex interaction between notes which is commonly used in pop, rock or heavy metal genres. In addition, the distortion produces output waveforms with high average power, particularly where the power amplifier saturates, so that the loudness of the amplifier for a given power rating is maximized.

Many of the properties of the electric guitar sound are related to the nonlinear behaviour of vacuum tube (valve) amplifiers, which were predominant when electric guitars were first developed. The majority of amplifiers built using modern technology seek to emulate the properties of tube amplifiers. See for example [E. Barbour: “The Cool Sound of Tubes”, IEEE Spectrum, pp 24-35, August 1998, E. K. Pritchard: “The Tube sound and Tube Emulators,” dB, pp 22-30, July/August 1994].

Many patents disclose devices that claim to emulate the operation of tube preamplifiers, which operate in class-A mode. Tube preamplifier stages produce bias-shifting when overdriven due to the grid conduction that occurs when the grid voltage exceeds the cathode voltage, in conjunction with the AC coupling between preamplifier stages. At high gains bias-shifting produces clipped waveforms resembling square waves with uneven mark-space ratios which include even harmonics. For example Sondermeyer [U.S. Pat. No. 5,619,578] discloses a multistage preamplifier using FETs with diode clipping to emulate grid conduction between stages.

Other patents disclose means for simulating one or more properties of tube power amplifiers, which typically operate in class AB or class B mode, having one or more symmetric pairs of output tubes coupled to the loudspeaker via an output transformer. Power amplifiers produce different characteristics to preamplifier tubes when overdriven. For example, symmetric-pair power stages produce crossover distortion when overdriven because grid conduction alters the input bias of the tubes. For example, Butler [U.S. Pat. No. 4,987,381] discloses a symmetric Mosfet output stage which claims to emulate the characteristics of vacuum tubes. Pritchard [U.S. Pat. Nos. 5,636,284 and 5,761,316] discloses means for emulating vacuum tube power amplifiers, including power supply compression effects, bias shifting due to grid conduction and variable output impedance. Sondermeyer [U.S. Pat. No. 5,524,055] also discloses a method for emulating the bias-shift due to grid conduction.

A feature of this form of crossover distortion is that as the input signal amplitude is reduced, the grid conduction ceases, and the crossover distortion disappears, so that the crossover artifacts only occur at high signal levels or high gains. This contrasts with crossover distortion in many solid state amplifiers, which is always present and so becomes objectionable at small signal levels.

A limitation of the emulation approach is that higher quality sound might in principle be achievable by modifying emulation circuitry so that it no longer precisely emulates a tube amplifier. For example, in the crossover distortion emulation circuits in U.S. Pat. Nos. 5,524,055 and 5,734,725, crossover distortion effects are obtained using diode clamping, which is highly nonlinear. This is reasonable for the emulation of the grid conduction that occurs in tubes when the input voltage rises above the bias voltage, but could be modified.

High quality guitar sound may also be achieved using circuitry that is significantly different to tube amplifiers. For example, one such technique is to filter the guitar signal into two or more frequency bands, to distort each band, and then to add the distorted bands together to produce a single output signal. Since notes with widely different frequencies fall within different frequency bands, the intermodulation distortion between those notes is reduced by this technique. The filter bands have sufficient and gradual overlap to ensure that some intermodulation occurs, and this produces a sound which is desirable for many music genres such as rock and heavy metal. This technique is discussed in [C. Anderton, “Four fuzzes in one with active EQ, Guitar Player, pp 37-46, June 1984], which discloses a four band system using standard bandpass filters.

An improvement to the bandpass filtering operation is to use equi-phase crossover networks to separate the signals into two or more bands as discussed in [M. Poletti, “An improved guitar preamplifier system with controllable distortion”, NZ Patent 329119], which is incorporated herein by reference. Equi-phase networks are commonly applied to multi-way loudspeaker systems [see for example S. H. Linkwitz, “Active crossover networks for noncoincident drivers,” J. Audio Eng. Soc., Vol. 24, No. 1, pp 2-8, January/February 1976] and have the advantage that the sum of the bands produces a flat frequency response, and so the bandsplitting and recombination operation does not alter the pre-existing frequency spectrum of the signal input to the bandsplitting network. When applied to nonlinear distortion of guitar signals, the output of the equi-phase system has a lower crest factor and a higher rms level than non-equi-phase systems and therefore produces a greater loudness for a fixed power amplifier rating, allowing it to better compete with tube amplifiers in which the power amplifier saturates.

The Effect of Crossover Distortion in Valve Power Amplifiers

An interesting characteristic of tube amplifiers is the crossover distortion that occurs in the power amplifier when overloaded. This process is discussed by Sondermeyer in [U.S. Pat. No. 5,524,055], where it is stated that when grid conduction occurs the output tubes become overbiased, causing crossover distortion, and that this reduces the peak clipping of the waveform. However, this reduction of peak clipping does not explain the spectrum of the output waveform, as will now be demonstrated.

FIG. 1 shows the output of a tube power amplifier driven into overload for a 250 Hz sinewave input, with a resistive load, with the recorded waveform normalized to a peak amplitude of one. The limiting of the peaks of the sinewave and the crossover distortion due to grid conduction are clear. The spectrum shows a modulated envelope, with both even and odd harmonics, and with a minimum in the envelope in the region of 1 kHz. This contrasts with the spectrum of a sinewave clipped to a similar level, as shown in FIG. 2, which has only odd harmonics, and an envelope which decays in a more monotonic manner with frequency and with only slight variations in magnitude. At higher gains the clipped sinewave becomes close to that of a square wave, and the spectrum consists of the fundamental plus all odd mth harmonics, with amplitudes 1/mth of that of the fundamental. The envelope of the spectrum then falls monotonically with frequency. However, with crossover distortion, the spectrum at higher gains maintains its modulated envelope. For example, FIG. 3 shows a heavily distorted sinewave with crossover distortion. The spectrum—shown in the middle plot of FIG. 3—shows a similar characteristic modulation of the spectrum to FIG. 1, with a first null at 4 kHz. Since most guitar amplifier loudspeakers roll off above 4 kHz, the reduction in the spectrum at 4 kHz will produce a reduction of high frequencies and an improvement in subjective sound quality compared to the spectrum without crossover distortion.

The characteristic modulation of the spectrum for heavily clipped sinewaves with crossover distortion may be explained by a Fourier analysis. The waveform is similar to a single period of a square wave with a “dead-zone” crossover region, as shown in FIG. 4. A single cycle of this waveform consists of two pulse signals, p_{τ/2}(t), of width τ/2, delayed by −T/4 and T/4, and with the second pulse inverted. For τ=T the crossover region is zero and the signal becomes one period of a square wave. The time signal can be written
s(t)=p_{τ/2}(t+T/4)−p_{τ/2}(t−T/4) 1
The Fourier transform is

$$S ( f ) = 2 j \frac{sin ( π f τ / 2 ) sin ( π f T / 2 )}{π f} \qquad 2$$

When the signal is repeated periodically, the spectrum is sampled at f=m/T, and scaled by 1/T, yielding the discrete spectrum of the periodic signal

$$S ( m ) = \frac{2 j}{m π} sin ( \frac{m π}{2} \frac{τ}{T} ) sin ( \frac{m π}{2} ) \qquad 3$$

For τ=T the sine terms become one and the spectrum reduces to

$$S ( m ) = \frac{2 j}{m π} , m odd \qquad 4$$

which is the spectrum of a square wave. For τ<T the product of the two sine terms produces a slowly varying envelope whose rate increases as τ reduces. The theoretical spectrum according to equation 3 is shown in the lower plot in FIG. 3 for τ/T=0.962, and is a reasonable match to the measured spectrum of the signal.

The modulation of the envelope increases as the degree of crossover distortion increases. FIG. 5 shows a sinewave distorted with a greater degree of crossover distortion. The first null in the envelope of the spectrum has reduced from 4 kHz to 2 kHz and the magnitude at 4 kHz is increased. The theoretical spectrum is shown with τ/T=0.92 and is a good match. Since 4 kHz is the typical upper limit of guitar loudspeakers, the increase in signal energy near 4 kHz increases the upper harmonics of the perceived waveform, which is likely to reduce the subjective sound quality.

Hence, the crossover distortion which occurs in tube amplifiers can produce a subjective improvement to the sound of distorted guitar signals, provided that the crossover effect is limited so that a reduction in spectral components occurs at the maximum frequencies which are transmitted by the guitar loudspeaker.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide a nonlinear processor for audio signals that is capable of producing controllable crossover-like distortion, or to at least provide the public with a useful choice.

### SUMMARY OF THE INVENTION

In a first aspect, the present invention broadly consists in a nonlinear processor for distorting audio signals, comprising: an input stage that is arranged to split an audio input signal into two signal paths; a pair of asymmetric distortion stages following the input stage such that there is one asymmetric distortion stage in each signal path, each asymmetric distortion stage having non-equal negative and positive saturation limits and a smooth transition between linear and nonlinear behaviour, and being arranged to produce a distorted output signal that has a mean signal level that is opposite in polarity to the other asymmetric distortion stage; a pair of AC-coupled symmetric distortion stages following the asymmetric distortion stages such that there is one symmetric distortion stage in each signal path, each symmetric distortion stage being arranged to nonlinearly limit the distorted signals in each signal path; and an output stage following the symmetric distortion stages that is arranged to add the two nonlinearly distorted signals from the symmetric distortion stages to generate an audio output signal that demonstrates a smooth transition from linear behaviour to the production of crossover-like artifacts.

In one form, the processor may be implemented in an analogue circuit wherein the input stage may be arranged to receive an analogue audio input signal, buffer the input signal, and split the input signal into two signal paths, and wherein the output stage may be arranged as a summer for adding the two analogue nonlinearly distorted signals from the symmetric distortion stages to generate a single analogue audio output signal.

In an alternative form, the processor may be implemented in a digital system wherein the input stage comprises an analogue-to-digital converter that may be arranged to receive an analogue audio input signal, convert the analogue input signal into a digital input signal, and split the digital input signal into two digital signal paths, and wherein the output stage may comprise: a summer that may be arranged to add the two digital nonlinearly distorted signals from the symmetric distortion stages to generate a single digital audio output signal; and a digital-to-analogue converter that may be arranged to convert the single digital audio output signal into a single analogue audio output signal.

In one form, the magnitude of the positive and negative saturation limits for one of the asymmetric distortion stages may be substantially equal to the magnitude of the negative and positive saturation limits respectively for the other asymmetric distortion stage so as to produce an audio output signal at the output stage that demonstrates a smooth transition from linear behaviour to the production of crossover-like artefacts.

In an alternative form, the magnitude of one or both of the positive and negative saturation limits for one of the asymmetric distortion stages may be different to the magnitude of the negative and positive saturation limits respectively for the other asymmetric distortion stage so as to produce an audio output signal at the output stage that demonstrates a smooth transition from linear behaviour to the production of crossover-like artefacts, with a spectrum which includes even harmonics of input frequencies of the audio input signal. Preferably, the magnitude of the positive saturation limit for one of the asymmetric distortion stages may be substantially higher than the magnitude of the negative saturation limit for the other asymmetric distortion stage.

Preferably, the symmetric distortion stages may each comprise a low-pass filter to provide a reduction of harmonic energy when nonlinearly limiting the distorted signals from the asymmetric distortion stages.

Preferably, the audio input signal may be from an electric or electronic musical instrument.

In a second aspect, the present invention broadly consists in a multiband nonlinear processor for distorting audio signals, comprising: an input stage that is arranged to receive an audio input signal: an equi-phase crossover network that is arranged to split the input signal into two or more frequency bands with finite overlap between the frequency bands, and equal phase responses in each band, and in each frequency band: an asymmetric distortion stage having non-equal negative and positive saturation limits and a smooth transition from linear to nonlinear behaviour, and where the saturation limits alternate across the frequency bands so as to produce distorted output signals having alternating polarity mean signal levels across the frequency bands; and an AC-coupled symmetric distortion stage following the asymmetric distortion stage that is arranged to nonlinearly limit the distorted output signal from the asymmetric distortion stage; and an output stage that is arranged to add the nonlinearly distorted signals from the symmetric distortion stages of all frequency bands to generate an audio output signal that demonstrates a smooth transition from linear behaviour to the production of crossover-like artifacts, with a reduction of intermodulation distortion.

In one form, the processor may be implemented in an analogue circuit wherein the input stage may be arranged to receive an analogue audio input signal and buffer it into the equi-phase crossover network, and wherein the output stage may be arranged as a summer for adding the analogue output signals from all the frequency bands to generate a single analogue audio output signal.

In another form, the processor may be implemented in a digital system, and wherein the input stage may comprise an analogue-to-digital converter that may be arranged to receive an analogue audio input signal and convert it into a digital input signal for the equi-phase crossover network, and wherein the output stage may comprise: a summer that may be arranged to add the digital output signals from all frequency bands to generate a single digital audio output signal; and a digital-to-analogue converter that may be arranged to convert the single digital audio output signal into a single analogue audio output signal.

In one form, the magnitude of the positive and negative saturation limits of each asymmetric distortion stage may be substantially equal to the magnitude of the negative and positive saturation limits respectively of adjacent asymmetric distortion stages of adjacent frequency bands so as to produce an audio output signal that demonstrates a smooth transition from linear behaviour to the production of crossover-like artifacts, with a reduction of intermodulation distortion.

In an alternative form, one or both of the positive and negative saturation limits of each asymmetric distortion stage may be different to the magnitude of the negative and positive saturation limits respectively of adjacent asymmetric distortion stages of adjacent frequency bands so as to produce an audio output signal that demonstrates a smooth transition from linear behaviour to the production of crossover-like artifacts, with a reduction of intermodulation distortion, and with a spectrum which includes even harmonics of the input frequencies of the audio input signal.

Preferably, the symmetric distortion stages may each comprise a low-pass filter to provide a reduction of harmonic energy when nonlinearly limiting the distorted signals from the asymmetric distortion stages.

Preferably, the multiband nonlinear processor may further comprise cross-coupling between the frequency bands before the distortion stages to allow the controlled increase of intermodulation distortion.

Preferably, the audio input signal may be from an electric or electronic musical instrument.

In a third aspect, the present invention broadly consists in a nonlinear audio distortion circuit for distorting audio signals from musical instruments, comprising: an input stage that is arranged to split an audio input signal into two signal paths; a pair of asymmetric distortion stages, one in each signal path, with non-equal negative and positive saturation limits, so as to produce opposite polarity mean signal levels at their outputs in each signal path, and which produce a smooth transition from linear to nonlinear behaviour; a pair of AC-coupled symmetric distortion stages, one in each signal path, following the asymmetric distortion stages; and an output stage that is arranged to add the two nonlinearly distorted signals from the symmetric distortion stages to generate an audio output signal that demonstrates a smooth transition from linear behaviour to the production of crossover-like artifacts.

In one form, the saturation limits in the two asymmetric distortion stages may be the opposite of each other so as to produce an audio output signal at the output stage that demonstrates a smooth transition from linear behaviour to the production of crossover-like artefacts.

In another form, the saturation limits of the two asymmetric distortion stages may be different to each other so as to produce a final audio output signal that demonstrates a smooth transition from linear behaviour to the production of crossover-like artefacts, with a spectrum which includes even harmonics of the input frequencies of the audio input signal.

Preferably, the symmetric distortion stages may each comprise an amplifier with a feedback loop that may be arranged to nonlinearly limit the signal of its signal path and a low-pass filter in the feedback loop that is arranged to provide a reduction of harmonic energy when limiting the signal.

The phrase “mean signal level(s)” in relation to the outputs of the asymmetric distortion stages, and in the context of polarity, is intended to cover the polarity of the time-average of the analogue outputs over a time equal to one or more periods of the input fundamental frequency in terms of voltage for the analogue implementation of the nonlinear processor and the sign of the time-average of the digital outputs over a time equal to one or more periods of the input fundamental frequency in terms of digital signal values for the digital implementation of the nonlinear processor.

The term ‘comprising’ as used in this specification means ‘consisting at least in part of’, that is to say when interpreting statements in this specification which include that term, the features, prefaced by that term in each statement, all need to be present but other features can also be present.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 shows temporal (top) and spectral (bottom) graphs of an output signal from a tube power amplifier that is driven into overload for a 250 Hz sinewave input;

FIG. 2 shows temporal (top) and spectral (bottom) graphs of a clipped sinewave;

FIG. 3 shows a temporal graph (top) of a heavily distorted sinewave with crossover distortion, a spectral graph (middle) calculated from the FFT of the heavily distorted sinewave, and a spectral graph (bottom) of the heavily distorted sinewave derived from the theoretical model of FIG. 4 with τ/T=0.962;

FIG. 4 shows a theoretical crossover distortion model;

FIG. 5 shows a temporal graph (top) of the heavily distorted sinewave of FIG. 3 with a greater degree of crossover distortion, a spectral graph (middle) calculated from the FFT of the heavily distorted sinewave with greater crossover distortion, and a spectral graph (bottom) of the heavily distorted sinewave with greater crossover distortion derived from the theoretical model of FIG. 4 with τ/T=0.92;

FIG. 6 shows a first preferred embodiment of the nonlinear processor of the present invention in the form of an analogue circuit for producing crossover-like artifacts;

FIGS. 7a and 7b show the transfer characteristics of the upper asymmetric and lower alternate asymmetric distortion amplifiers respectively of the analogue circuit of FIG. 6;

FIG. 8 shows modelled temporal graphs of the output waveforms from the upper asymmetric (top) and lower alternate asymmetric (bottom) distortion amplifiers of the analogue circuit of FIG. 6, with the output waveforms after AC-coupling shown dashed;

FIG. 9 shows modelled temporal graphs of the output waveforms from the upper (top) and lower (bottom) symmetric distortion amplifiers of the circuit of FIG. 6;

FIG. 10 shows modelled temporal (top) and spectral (bottom) graphs of the output waveform from the summer operational amplifier of the analogue circuit of FIG. 6;

FIG. 11 shows the modelled temporal (top) and spectral (bottom) graphs of the output waveform from FIG. 10, but where the saturation levels of the asymmetric distortion amplifiers are different to each other, resulting in a reduced width in the positive cycle and additional even harmonics;

FIG. 12 shows a schematic block diagram of a second preferred embodiment of the nonlinear processor of the present invention in the form of a digital system for generating signal limiting and crossover-like artifacts;

FIGS. 13a and 13b show the transfer characteristics of the upper asymmetric and lower alternate asymmetric distortion stages respectively of the digital system of FIG. 12;

FIG. 14 shows a third preferred embodiment of the nonlinear processor of the present invention in the form of a four-band analogue circuit for producing crossover-like artifacts with controllable intermodulation distortion;

FIGS. 15a-15c show examples of typical high-pass, low-pass and all-pass filters, respectively, that may be implemented in the analogue circuit of FIG. 14;

FIG. 16 shows modelled temporal graphs of the output waveforms from the asymmetric distortion stages of channels 1-4 of the four-band analogue circuit of FIG. 14 for an input of 150 Hz;

FIG. 17 shows modelled temporal graphs of the output waveforms from the symmetric distortion stages of channels 1-4 of the four-band analogue circuit of FIG. 14 for an input of 150 Hz;

FIG. 18 shows modelled temporal (top) and spectral (lower) graphs of the output waveform from the summer operational amplifier of the output stage of the four-band analogue circuit of FIG. 14 for an input of 150 Hz;

FIG. 19 shows modelled temporal (top) and spectral (bottom) graphs of the output waveform from FIG. 18, but where the saturation levels of each of the asymmetric distortion stages are different or unmatched relative to those of the adjacent asymmetric distortion stages, resulting in a reduced width in the positive cycle and increased even harmonics;

FIG. 20 shows modelled temporal graphs of the output waveforms from the asymmetric distortion stages of channels 1-4 of the four-band analogue circuit of FIG. 14 for an input of 1.5 kHz;

FIG. 21 shows modelled temporal (top) and spectral (bottom) graphs of the output waveform from the summer operational amplifier of the output stage of the four-band analogue circuit of FIG. 14 for an input of 1.5 kHz;

FIG. 22 shows a schematic block diagram of a fourth preferred embodiment of the nonlinear processor of the present invention in the form of four-band digital system for producing crossover-like artifacts with controllable intermodulation distortion; and

FIG. 23 shows modelled temporal (top) and spectral (bottom) graphs of the output waveform of the output stage of the digital system of FIG. 22 with a non-equi-phase bandsplitter for an input of 150 Hz.

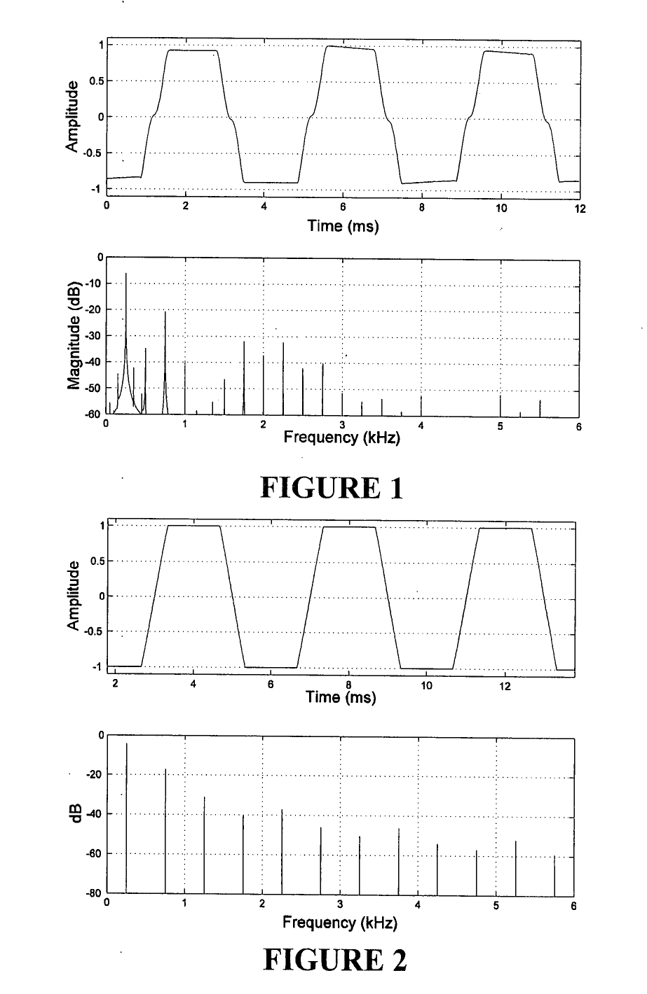

### DETAILED DESCRIPTION OF PREFERRED EMBODIMENTS

The present invention is directed at a nonlinear processor for audio signals that is capable of producing controllable crossover-distortion-like effects without requiring the use of D.C. biasing, and which can produce a more gradual transition into crossover distortion than obtained by tube emulation. The nonlinear processor can be implemented in analogue or digital form as will be described, by way of example, with reference to the first and second preferred embodiments of FIGS. 6 and 12 respectively.

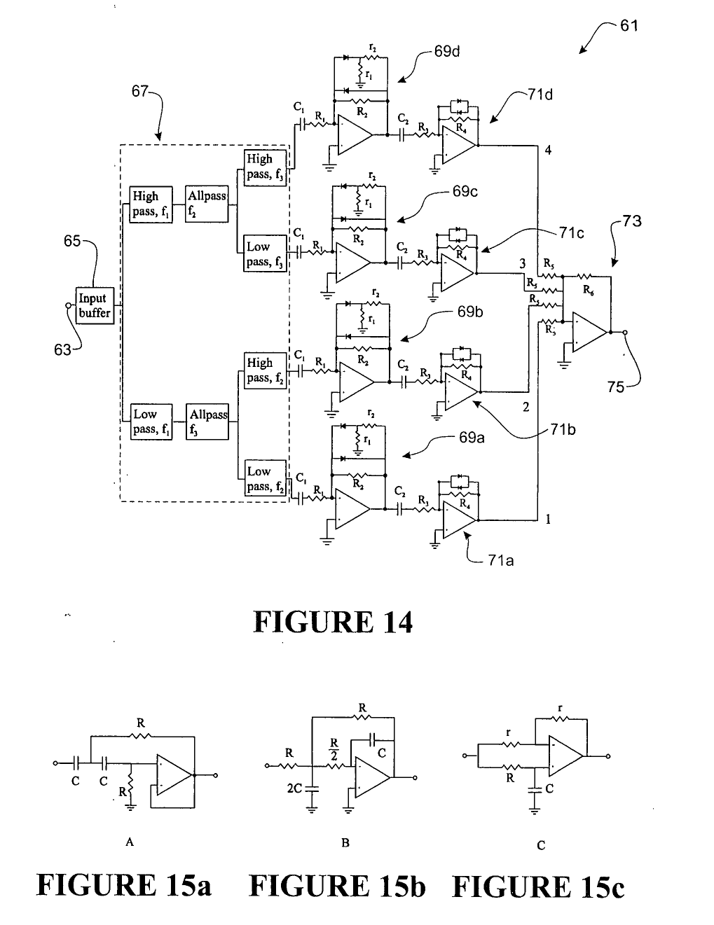

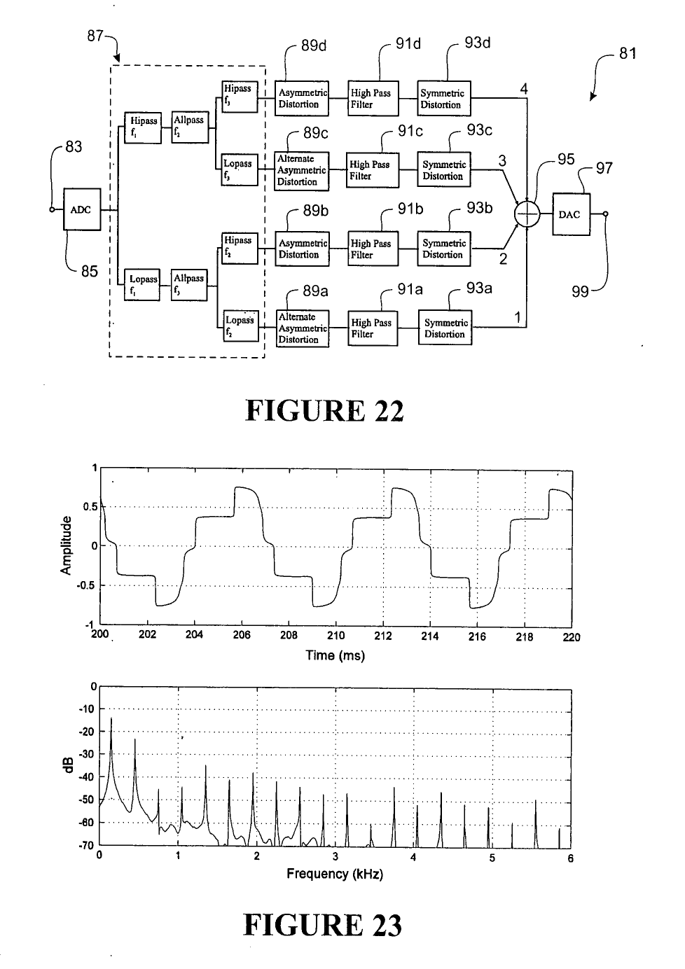

The present invention may also enable the incorporation of controllable crossover-like effects into a multiband nonlinear processor to reduce harmonic distortion while also offering control of intermodulation distortion. The multiband nonlinear processor may also be implemented in analogue or digital form as will be explained with reference to the third and fourth preferred embodiments of FIGS. 14 and 22 respectively.

Referring to FIG. 6, the first preferred embodiment of the nonlinear processor is shown in the form of a solid-state analogue circuit 11. The analogue circuit 11 will now be explained in more detail below. The analogue circuit 11 is capable of producing amplitude-dependent crossover distortion where the distortion is minimal for small signal amplitudes and the transition into crossover effects is gradual.

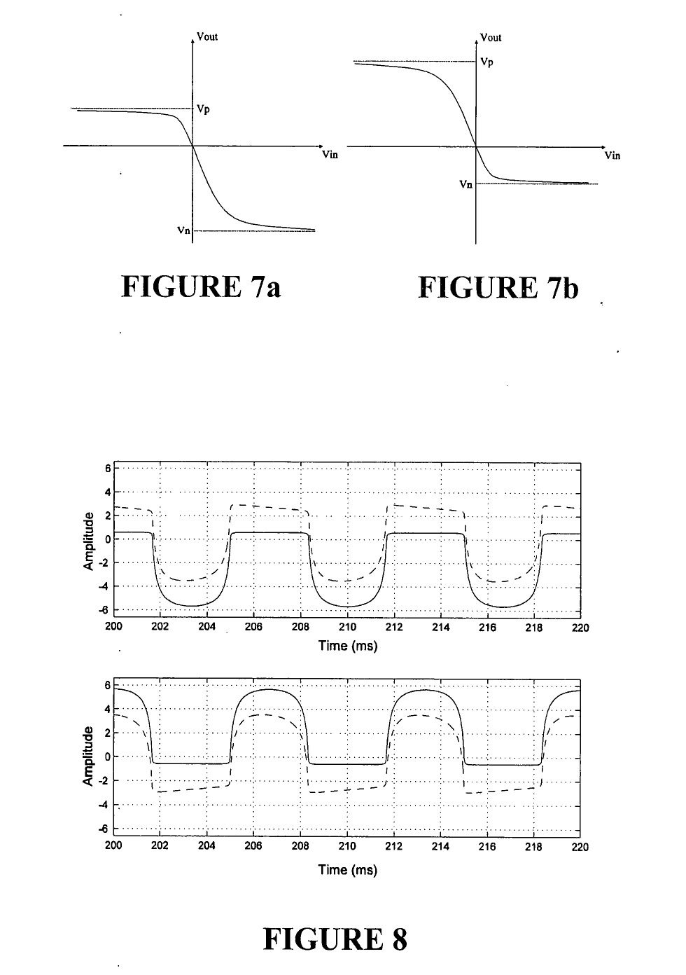

The input 13 is connected to an input stage 15, for example a unity gain buffer circuit, whose output is connected to two class A circuits which operate in parallel upper 16 and lower 18 channels. The first amplifier circuit 17, 19 in each channel has an asymmetric, nonlinear transfer characteristic. The gain of each amplifier circuit 17, 19 for small input voltages is −R₂/R₁. At larger voltages the gain reduces due to the conduction of the diodes in the feedback network in parallel with R₂ and r₁ and r₂, which are typically smaller than R₂. Since the circuits 17, 19 use diodes in the feedback loop of the operational amplifiers, the transfer characteristic is smoother than can be obtained using a diode clipper with diodes connected to ground. Furthermore, the negative output voltage saturation limit of the asymmetric distortion stage is different to the positive output voltage saturation limit. For example, for the lower channel 18 the negative limit is the diode voltage, V_{d}, required to maintain the virtual earth condition, which would typically be of the order of −0.6 volts. The positive limit is (1+ r₂/r₁)V_{d} for example with r₁=100 Ohms and r₂=1 kOhm the positive limit would be about 6.6 volts. The transfer characteristic therefore typically has the form of FIG. 7b, where Vₙ=−0.6 and Vₚ=6.6. Note that the transfer characteristic includes the inversion of the input voltage due to the inverting configuration of the operational amplifier circuit 19.

The upper channel 16 uses the same circuit, but the asymmetry has the opposite polarity to the lower channel 18. With the same values of r₁ and r₂ the negative saturation limit would be −6.6 volts and the positive voltage saturation limit 0.6 volts, and the transfer characteristic would have the alternate asymmetry, as shown in FIG. 7a, including inversion of the input voltage.

Due to the non-equal clipping voltages, the output waveforms from the asymmetric amplifier circuits 17, 19 of the two channels 16, 18 have non-zero average voltages with opposite polarities, a representative waveform of which is shown in FIG. 8. These signal voltages are preferably AC coupled into the next stages, which removes the DC offsets from the two signals. The AC coupled waveforms are shown dashed in FIG. 8.

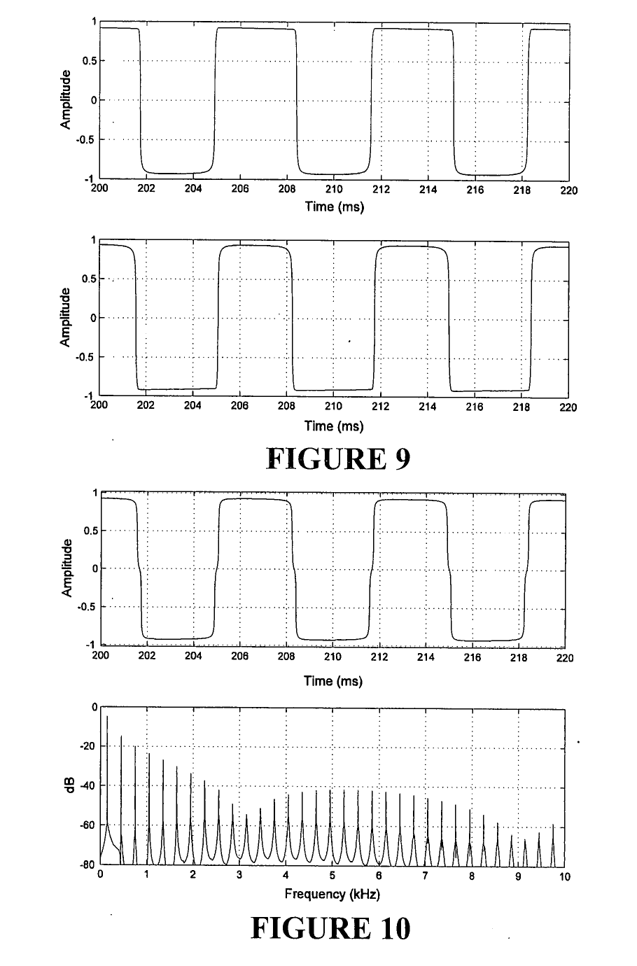

The following nonlinear amplifier stages 21, 23 are arranged to nonlinearly limit the waveforms in each of the channels 16, 18 symmetrically with respect to each other. The gain for small signal voltages is −R₄/R₃, and this reduces for large input voltages, and the reduction in gain is equal for positive or negative input voltages. Because of the asymmetry of the input waveforms, the output waveforms from the symmetric amplifier circuits 21, 23 produce distorted waveforms with unequal durations of negative and positive going excursions (an unequal “mark-space” ratio), as shown in FIG. 9.

The two symmetric distortion outputs are added in an output stage with equal gains −R₆/R₅ in the final summer operational amplifier circuit 25, producing an output 27 with characteristics similar to those of crossover distortion, as shown in FIG. 10, although it is produced by a different mechanism to that which occurs in a tube amplifier. Furthermore, the transition into crossover distortion is smoother than prior art methods, because the diodes in the asymmetric distortion stages 17, 19 are in the feedback loops of the operational amplifiers. This produces a gradual, rounded clipping of the signals which does not occur in tube grid conduction, and this helps to produce a slower transition into asymmetry.

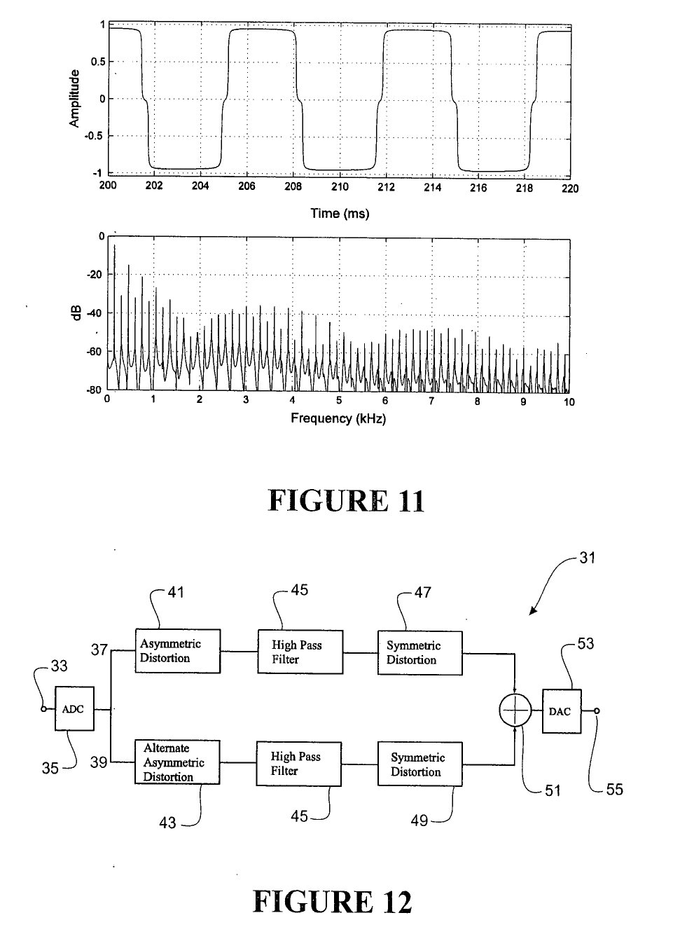

If the two asymmetric stages 17, 19 have different saturation levels but still produce opposite polarity mean voltages at their outputs, crossover distortion will still occur, but the width of the positive and negative halves of the waveform will differ. This introduces even harmonics into the spectrum. For example, if the asymmetric amplifier circuit 19 of the lower channel 18 stage has voltage saturation limits of Vₙ=−6.6 and Vₚ=0.6 and the alternate asymmetric amplifier circuit 17 of the upper stage has saturation limits Vₙ=0.6 and Vₚ=26.4, then the output 27 in FIG. 11 is produced. The positive half of the waveform exhibits a narrower width than the negative half, and the spectrum shows odd harmonics, and even harmonics at a lower level relative to the adjacent odd harmonics. The degree of crossover is also increased, altering the modulation of the spectrum. The addition of even harmonics creates a subjectively different sound quality and this is a desirable option which can be implemented as required. This feature is easily implemented using the analogue circuit 11 of FIG. 6, but does not occur under normal operation in a tube power amplifier, giving the nonlinear processor a flexibility which exceeds that of the tube power amplifier.

The nonlinear processor, shown in FIG. 6 as analogue circuit 11, may also be implemented digitally as will be described with reference to the second preferred embodiment of the nonlinear processor, in particular the digital system 31 of FIG. 12.

The analogue input signal 33 is first sampled at the input stage in an analogue-to-digital converter (ADC) 35 at a rate sufficiently high to accommodate the distortion products generated by the subsequent nonlinear processing. The sampled signal is then split into upper 37 and lower 39 channels. An asymmetric distortion stage 41 is applied to the upper channel 37, and an alternate asymmetric distortion stage 43 is applied to the lower channel 39. The outputs from the asymmetric distortion stages 41, 43 are then preferably high-pass filtered 45 (AC coupled) to remove the DC component. Each AC coupled sampled waveform is then applied to symmetric distortion stages 47, 49 provided in the upper 37 and lower 39 channels. The outputs from the symmetric distortion stages 47, 49 are then added together at the output stage by summer 51. The output of the summer 51 is then applied to a digital-to-analogue converter (DAC) 53 that provides a single analogue output 55 demonstrating crossover-like artifacts.

A method of producing an asymmetric, nonlinear transfer characteristic for the asymmetric distortion stages 41, 43 of the digital system 31 is

$$f ( x ) = \begin{matrix}\frac{gx}{1 - gx / {L}_{n}} , & x \leq 0 \\ \frac{gx}{1 + gx / {L}_{p}} , & x > 0\end{matrix} \qquad 5$$

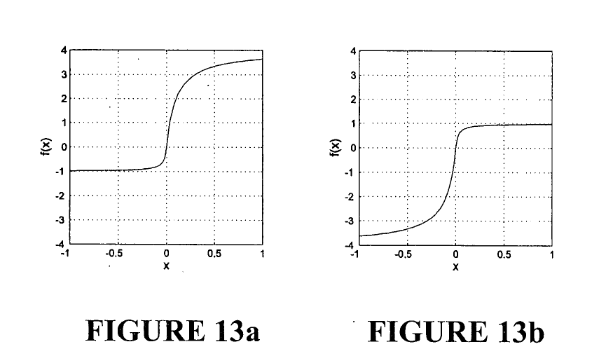

which is a simplification and modification of the function given in [M. C. Jeruchim, P. Balaban and K. S. Shanmugan, Simulation of Communication Systems, Plenum Press, 1992]. This produces a gain g for x=0, a negative limit of f(x)=−Lₙ for x<<0 and a positive limit of f(x)=Lₚ for x>>0. For example, a transfer characteristic for the asymmetric distortion stage 41 of the upper channel 37 is shown in FIG. 13a for g=40, a negative limit of −1 and a positive limit of 4. FIG. 13b shows the alternate transfer characteristic for the alternate asymmetric distortion stage 43 of the lower channel 39 with the same gain, a negative limit of −4 and a positive limit of 1. These transfer characteristic curves are similar in form to those shown in FIGS. 7a and 7b in relation to analogue circuit 11, but do not include inversion of the input signal.

The high-pass filter stages 45 may be implemented using standard first order filter designs such as a digital Butterworth filter or any other type of suitable filters. Higher order filters may also be utilised if desired. The symmetric distortion stages 47 may be obtained using equation 5, with Lₙ=Lₚ.

The modelled waveforms shown in FIGS. 8 to 10 were obtained using equation 5 with Lₙ=−6.6 and Lₚ=0.6 for the upper channel asymmetric distortion stage 41 and Lₙ=−0.6 and Lₚ=6.6 for the lower channel alternate asymmetric distortion stage 43, and are essentially similar in form to the analogue voltages waveforms produced by the analogue circuit 11 in FIG. 6. Both Lₙ and Lₚ were set to one for the symmetric distortion stages 47, 49. In FIG. 11 the upper channel asymmetric distortion stage 41 used Lₚ=24.6 to produce additional even harmonics of the input frequency. A sample rate of 176400 Hz was used, and digital high-pass filters 45 each with a 10 Hz cut off were utilised (with feedforward coefficients 0.9998 and −0.9998, and feedback coefficient −0.9996). The input sinewave had a frequency of 150 Hz and amplitude 1 and the asymmetric stage gains were 40 and the symmetric stage gains were 4.

As mentioned, the nonlinear processor may be implemented in a multiband form to reduce harmonic distortion and to provide controllable crossover-like artifacts and reduced intermodulation distortion. Referring to FIG. 14, a third preferred embodiment of the nonlinear processor in the form of a solid-state multiband analogue circuit 61 is shown. This embodiment will be explained in more detail below.

The analogue input signal 63 is first buffered at an input stage by input buffer 65 in a similar manner to analogue circuit 11 described with reference to FIG. 6. The buffered output is then split into four frequency bands using an equi-phase bandsplitter 67, an example of which is as discussed in NZ Patent 329119. The low-pass, high-pass and all-pass filters of the bandsplitter 67 may be implemented, for example, as shown in FIG. 15a (second order high-pass), 15b (inverting, second order low-pass) and 15c (first order all-pass). The four outputs or frequency bands from the bandsplitter are fed into four asymmetric distortion stages 69a-69d. The small-signal gains of these stages are −R₂/R₁, and the gain reduces at higher signal levels due to the conduction of the diodes in series with R₂ and the feedback resistors r₁ and r₂, which are typically smaller than R₂. The asymmetry in each band is of the opposite polarity to that in the adjacent band or channel. Specifically, the asymmetric distortion stage 69a in channel one has a large positive output voltage saturation limit of approximately (1+r₂/r₁)V_{d} and a small negative voltage saturation limit of −V_{d}. The asymmetric distortion stage 69b in channel two has the opposite polarity to that in channel one, with small positive output voltage limit V_{d} and large negative voltage limit −(1+ r₂/r₁)V_{d}. The asymmetric distortion stage 69c of channel three has the opposite polarity to that in channel two, and the same polarity as that in channel one. Finally, the asymmetric distortion stage 69d of channel four has the opposite polarity to that in channel three, but the same polarity to that in channel two. In summary, the asymmetry alternates across the four channels or frequency bands.

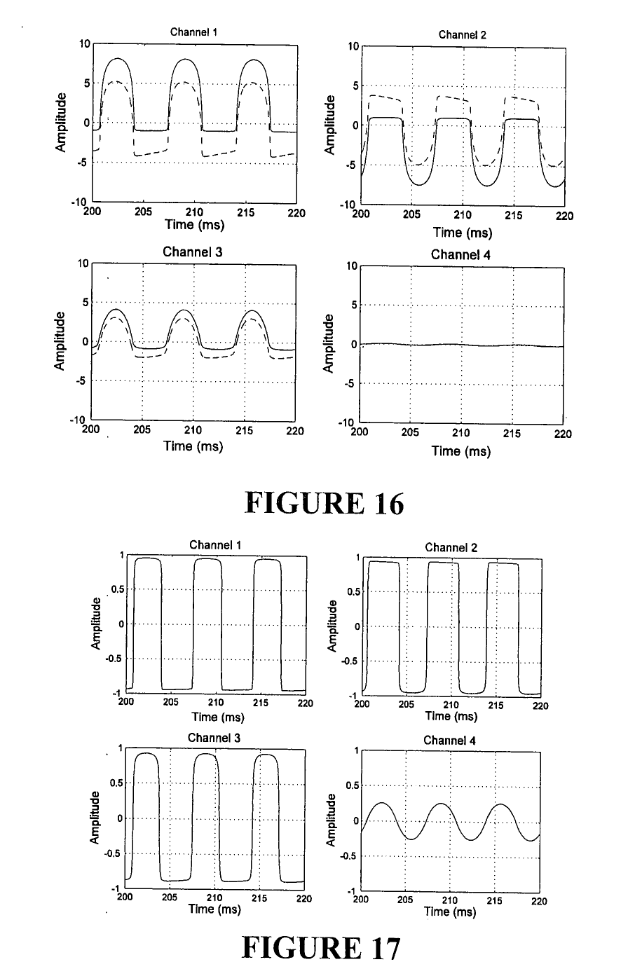

Representative waveforms at the outputs of the asymmetric distortion stages 69a-69d, and their dashed AC-coupled forms, are shown in FIG. 16, for an input 63 having a signal frequency of 150 Hz. The signal energy is predominantly in channels one and two (since adjacent channels overlap due to the finite roll-off of the bandsplitting filters). The asymmetry alternates across the channels, but the signal amplitude is reduced in the upper two channels.

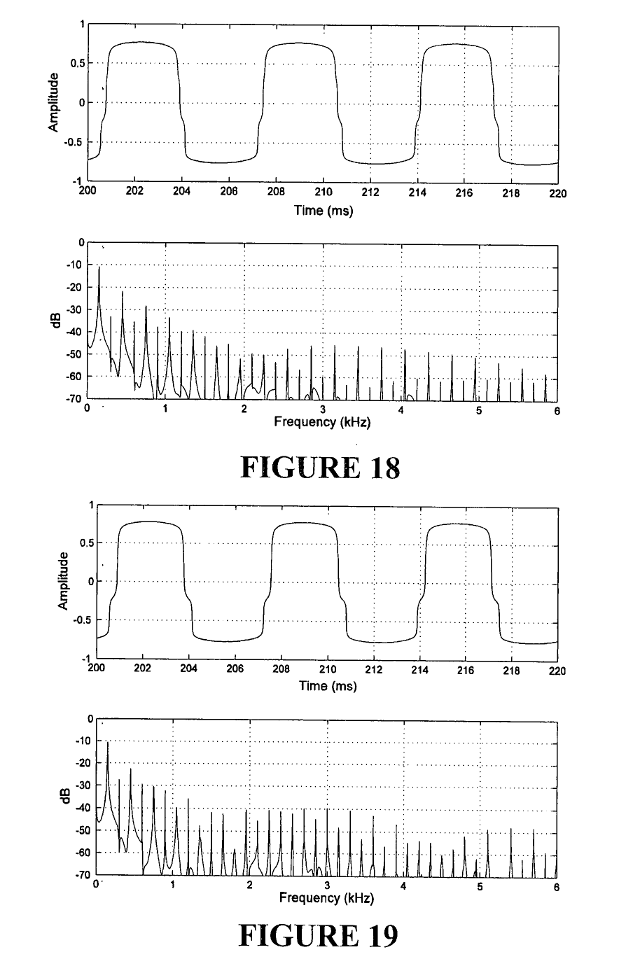

The outputs from the asymmetric distortion stages 69a-69d are AC-coupled into symmetric distortion stages 71a-71d. These have gains of −R₄/R₃ for small voltages, and the gain reduces for large input voltages, and the reduction in gain is approximately equal for positive or negative input voltages. In those channels where the signal energy is sufficiently large, this produces waveforms with non-even mark-space ratios. A representative example is shown in FIG. 17 for a 150 Hz sinewave input 63. The first and second channels produce distorted waveforms which are similar to square waves, and which have non-equal mark-space ratios. The sum of these waveforms generated by summing circuit 73 of the output stage produces an output 75 with crossover effects reminiscent of standard crossover distortion, the waveform and spectrum of which are shown in FIG. 18.

In tube amplifiers, the crossover distortion in the output waveform occurs at zero volts for a symmetrical output stage. The crossover effect in FIG. 18 occurs at a voltage which depends on the input sinewave and the bandsplitting frequencies, and may not be at zero volts. The spectrum of the waveform shows the typical characteristic of crossover distortion, with a modulation of the spectral envelope, as shown in the lower graph of FIG. 18. The waveform is non-symmetric for a non-zero crossover voltage, and as a result the spectrum includes even harmonics of the input frequency. The inclusion of even harmonics due to this waveform asymmetry can be subjectively desirable. The effect can be increased or decreased by altering the saturation limits as discussed in relation to FIG. 6, and shown in FIG. 11. FIG. 19 shows the waveform of the output 75 for negative saturation limits of 1, 10, 1 and 10, and positive saturation limits of 40, 1, 40 and 1. The positive half of the waveform has a reduced width, and this further enhances the even harmonics compared to FIG. 18. If the positive saturation limits were instead decreased to less than 10, then the even harmonics would be reduced.

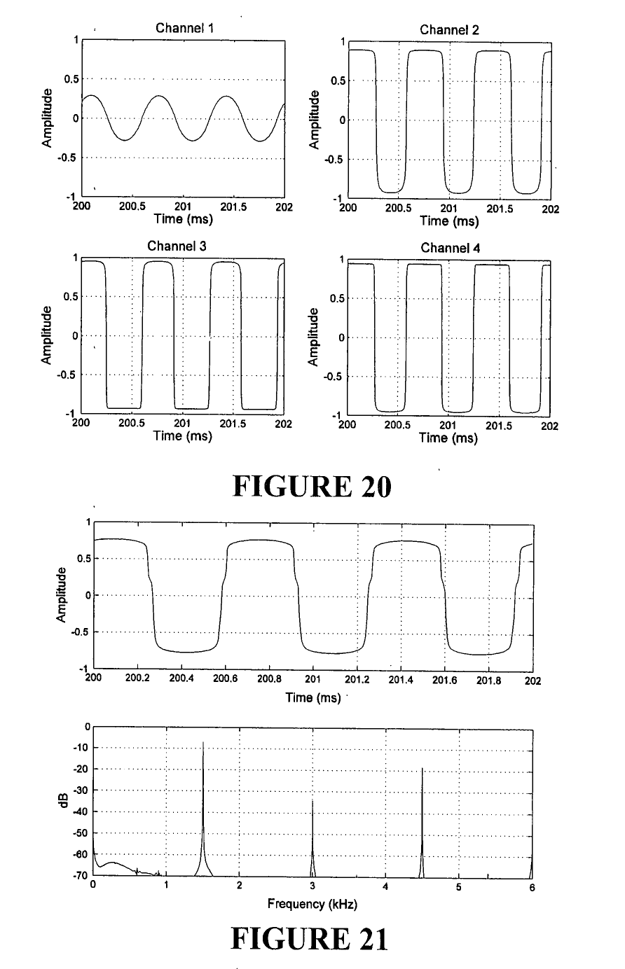

In addition to producing crossover distortion effects, the analogue circuit 61 of FIG. 14 also produces reduced intermodulation distortion between frequencies which are sufficiently separate to fall predominantly into different channels. For example, FIG. 20 shows the output of the symmetric distortion stages 71a-71d for a 1.5 kHz sinewave input 63. The energy in the signal now resides predominantly in the third and fourth channels, as opposed to the first and second as in FIG. 17. FIG. 21 shows the combined waveform at the output 75 which produces crossover-like artifacts at a positive voltage. Since the 150 Hz and a 1.5 kHz signals occur predominantly in different channels, the intermodulation between these two frequencies will be significantly reduced, and the output of the circuit for an input consisting of the sum of the two sinewaves will be predominantly the sum of the waveforms in FIGS. 18 and 21.

The multiband nonlinear processor, shown in FIG. 14 as analogue circuit 61, may also be implemented digitally as will be described with reference to the fourth preferred embodiment of the nonlinear processor, in particular the digital system 81 of FIG. 22.

The analogue input signal 83 is first sampled at the input stage by ADC 85 at a rate sufficiently high to accommodate the distortion products generated by the subsequent nonlinear processing. The sampled signal is split into four channels or frequency bands by an equi-phase bandsplitter 87 that, for example, utilises digital filters obtained from the bilinear transform of the filters in FIGS. 15a-15c. Asymmetric distortion stages 89a-89d are provided in each channel, for example using the nonlinear function in equation 5. These asymmetric distortion stages 89a-89d alternate across the four channels in a similar manner to that described in relation to the analogue circuit 61 of FIG. 14, with opposite polarities between even and odd channels. The outputs of the asymmetric distortion stages 89a-89d are AC-coupled using high-pass digital filters 91a-91d and fed into symmetric distortion stages 93a-93d, using for example equation 5 with equal negative and positive limits. The outputs of the symmetric distortion stages 93a-93d are then added together at the output stage by summer 95 to produce, after being fed through DAC 97, an analogue output 99 with similar properties to the output of the analogue circuit 61 of FIG. 14. The control of even harmonics can be implemented in similar form to FIG. 14 by adjusting the relative saturation limits of the asymmetric distortion stages 89a-89d, whilst maintaining opposite polarities of their mean output waveforms between adjacent channels.

It will be appreciated that the multiband nonlinear processor may be arranged to split the input signal into two or more frequency bands or channels, and that the four-band embodiments are provided by way of example only.

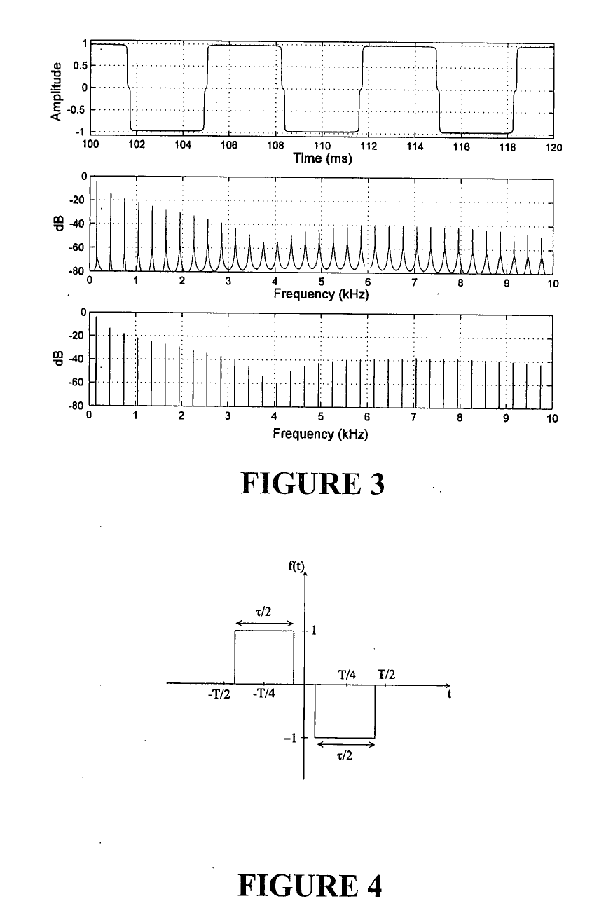

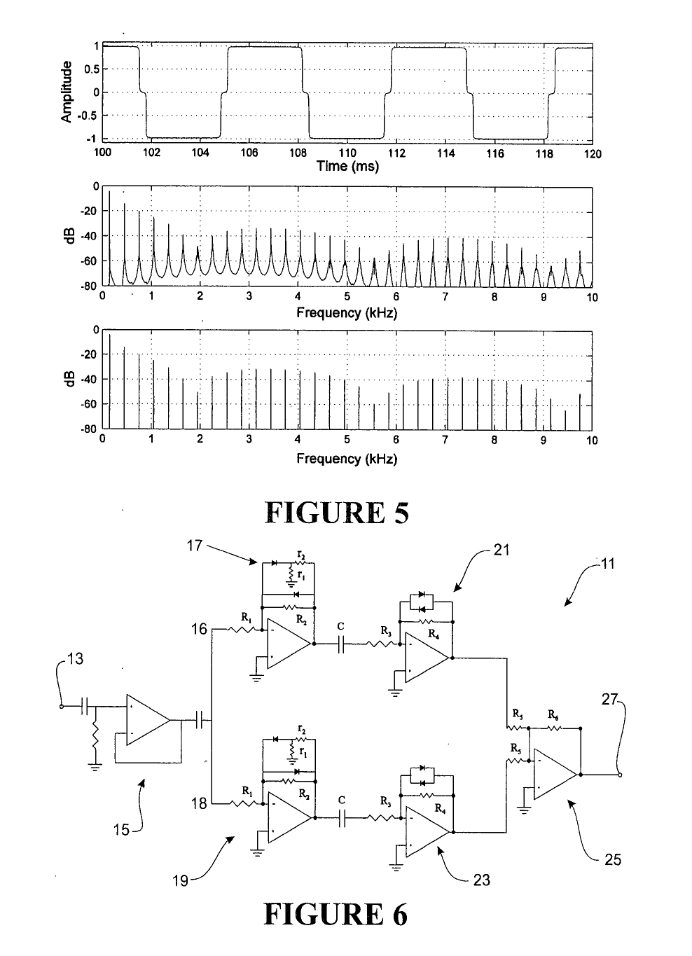

A distinction should be made between the effects on sound quality of using a prior-art, non-equi-phase, bandpass-filter-based bandsplitter with different phase responses between bands and symmetric distortion, as in [C. Anderton, “Four fuzzes in one with active EQ, Guitar Player, pp 37-46, June 1984], and the method disclosed here. The use of non-equi-phase bandsplitting produces waveforms in each band with widely different phase responses. This occurs because each bandpass filter must be positioned at a different frequency, and so the phase responses must be different between filters. This means that, when the bands are combined, the degree of crossover distortion is significant, and is frequency-dependent. Severe crossover artifacts occur at most frequencies within the range of interest which—as shown in FIGS. 3 and 5—does not produce a reduction of high frequency harmonics near the bandlimit of the guitar loudspeaker, and hence produces no benefit. In addition, the waveforms produced in the non-equi-phase case can have high crest factors.

For example, FIG. 23 shows the output of a multiband nonlinear processor using four bandpass filters with non-equi-phase responses (with center frequencies 100, 300, 900 and 2700 Hz), for a 150 Hz input signal. At 150 Hz the phase difference between bands one and two is about 90 degrees. The output waveform therefore produces maximal forms of crossover distortion, as shown, and the crest factor of the output is 4 dB as opposed to 1.5 dB in FIG. 18. This means that the non-equi-phase waveform will not be as loud as the equi-phase waveform when transmitted from a power amplifier with limited headroom.

Further, prior art bandsplitters will always produce the most extreme crossover in the region where bandsplitting is applied, since this is where the phase differences are maximum, so the problem is difficult to avoid without employing equi-phase bandsplitting as described in NZ Patent 329119. Furthermore, the crossover distortion caused by non-equi-phase networks occurs at all signal levels, since it is not the result of asymmetric distortion as used in the present invention, or bias shift as in the tube amplifier case. Therefore non-equi-phase bandsplitting will produce significant effects at lower signal amplitudes, whereas in the method disclosed here crossover distortion disappears at small signal levels, which is more desirable. Lastly, due to the symmetric distortion in each stage, the prior art circuit produces only odd harmonics, with no control of even harmonics. The use of equi-phase bandsplitting and controlled alternating asymmetry as described herein thus provides for output waveforms with controllable crossover distortion artifacts at all frequencies which remain subjectively desirable for all input signals, which are signal-level-dependent, and the output waveform always exhibits a low crest factor which maximizes loudness.

It will be understood that various modifications can be made to the analogue circuits of FIGS. 6 and 14 without substantially altering their operation, or which further enhance the subjective sound quality. For example, input gain and equalisation may be applied to the signal before nonlinear processing, and equalization (tone controls) may be applied to the output of the nonlinear processor. Low-pass filters may be placed after the symmetric distortion stages, or symmetric distortion stages used which incorporate low-pass filters as discussed in NZ Patent 329119. The asymmetric distortion circuits may be simplified by removing r₁. Alternative forms of asymmetric distortion stages may use transistors to provide continuously variable voltage limits, or diodes with different on-voltages, such as zener or light emitting diodes. Different forms of asymmetric distortion may be used in each channel to produce crossover-like artifacts, the spectrum of which includes even harmonics of the input signal. Symmetric distortion stages with different nonlinear elements in the feedback loop may also be used such as light emitting diodes, zener diodes or transistors, or circuits without nonlinear elements in the feedback loop such as a resistor and pairs of diodes to ground may be used to produce increased harmonic energy for more extreme sounds. Lastly, deliberate cross coupling between the bandsplitter outputs before nonlinear distortion may be introduced to allow the controlled increase of intermodulation distortion for musical purposes, or alternatively, controlled nonlinear distortion of the combined output may be added for similar reasons. Similarly, it will be appreciated that various modifications may be made to the digital systems of FIGS. 12 and 22 if desired. For example, input gain and equalisation may be applied to the signal after sampling by the ADC and before nonlinear processing, and equalization (tone controls) may be applied to the output of the nonlinear processor before conversion to an analogue signal by the DAC. Low-pass filters may be placed after the symmetric distortion stages, or symmetric distortion stages used which incorporate low-pass filters as discussed in NZ Patent 329119.

The nonlinear processor is primarily designed for distorting audio signals from electric and electronic instruments such as guitars and keyboards, and other recorded acoustic instruments. However, it will be appreciated that the nonlinear processor may be arranged to distort audio signals generated by any number of different types of sources.

The foregoing description of the invention includes preferred forms thereof. Modifications may be made thereto without departing from the scope of the invention as defined by the accompanying claims.

1. A nonlinear processor for distorting audio signals, comprising:
an input stage that is arranged to split an audio input signal into two signal paths;
a pair of asymmetric distortion stages following the input stage such that there is one asymmetric distortion stage in each signal path, each asymmetric distortion stage having non-equal negative and positive saturation limits and a smooth transition between linear and nonlinear behaviour, and being arranged to produce a distorted output signal that has a mean signal level that is opposite in polarity to the other asymmetric distortion stage;
a pair of AC-coupled symmetric distortion stages following the asymmetric distortion stages such that there is one symmetric distortion stage in each signal path, each symmetric distortion stage being arranged to nonlinearly limit the distorted signals in each signal path; and
an output stage following the symmetric distortion stages that is arranged to add the two nonlinearly distorted signals from the symmetric distortion stages to generate an audio output signal that demonstrates a smooth transition from linear behaviour to the production of crossover-like artifacts.

2. A nonlinear processor according to claim 1 in which the processor is implemented in an analogue circuit wherein the input stage is arranged to receive an analogue audio input signal, buffer the input signal, and split the input signal into two signal paths, and wherein the output stage is arranged as a summer for adding the two analogue nonlinearly distorted signals from the symmetric distortion stages to generate a single analogue audio output signal.

3. A nonlinear processor according to claim 1 in which the processor is implemented in a digital system wherein the input stage comprises an analogue-to-digital converter that is arranged to receive an analogue audio input signal, convert the analogue input signal into a digital input signal, and split the digital input signal into two digital signal paths, and wherein the output stage comprises: a summer that is arranged to add the two digital nonlinearly distorted signals from the symmetric distortion stages to generate a single digital audio output signal; and a digital-to-analogue converter that is arranged to convert the single digital audio output signal into a single analogue audio output signal.

4. A nonlinear processor according to claim 1 wherein the magnitude of the positive and negative saturation limits for one of the asymmetric distortion stages is substantially equal to the magnitude of the negative and positive saturation limits respectively for the other asymmetric distortion stage so as to produce an audio output signal at the output stage that demonstrates a smooth transition from linear behaviour to the production of crossover-like artefacts.

5. A nonlinear processor according to claim 1 wherein the magnitude of one or both of the positive and negative saturation limits for one of the asymmetric distortion stages is different to the magnitude of the negative and positive saturation limits respectively for the other asymmetric distortion stage so as to produce an audio output signal at the output stage that demonstrates a smooth transition from linear behaviour to the production of crossover-like artefacts, with a spectrum which includes even harmonics of input frequencies of the audio input signal.

6. A nonlinear processor according to claim 5 wherein the magnitude of the positive saturation limit for one of the asymmetric distortion stages is substantially higher than the magnitude of the negative saturation limit for the other asymmetric distortion stage.

7. A nonlinear processor according to claim 1 wherein the symmetric distortion stages each comprise a low-pass filter to provide a reduction of harmonic energy when nonlinearly limiting the distorted signals from the asymmetric distortion stages.

8. A nonlinear processor according to claim 1 wherein the audio input signal is from an electric or electronic musical instrument.

9. A multiband nonlinear processor for distorting audio signals, comprising:
an input stage that is arranged to receive an audio input signal:
an equi-phase crossover network that is arranged to split the input signal into two or more frequency bands with finite overlap between the frequency bands, and equal phase responses in each band, and in each frequency band:
an asymmetric distortion stage having non-equal negative and positive saturation limits and a smooth transition from linear to nonlinear behaviour, and where the saturation limits alternate across the frequency bands so as to produce distorted output signals having alternating polarity mean signal levels across the frequency bands; and
an AC-coupled symmetric distortion stage following the asymmetric distortion stage that is arranged to nonlinearly limit the distorted output signal from the asymmetric distortion stage; and
an output stage that is arranged to add the nonlinearly distorted signals from the symmetric distortion stages of all frequency bands to generate an audio output signal that demonstrates a smooth transition from linear behaviour to the production of crossover-like artifacts, with a reduction of intermodulation distortion.

10. A multiband nonlinear processor according to claim 9 in which the processor is implemented in an analogue circuit wherein the input stage is arranged to receive an analogue audio input signal and buffer it into the equi-phase crossover network, and wherein the output stage is arranged as a summer for adding the analogue output signals from all the frequency bands to generate a single analogue audio output signal.

11. A multiband nonlinear processor according to claim 9 in which the processor is implemented in a digital system, and wherein the input stage comprises an analogue-to-digital converter that is arranged to receive an analogue audio input signal and convert it into a digital input signal for the equi-phase crossover network, and wherein the output stage comprises: a summer that is arranged to add the digital output signals from all frequency bands to generate a single digital audio output signal; and a digital-to-analogue converter that is arranged to convert the single digital audio output signal into a single analogue audio output signal.

12. A multiband nonlinear processor according to claim 9 wherein the magnitude of the positive and negative saturation limits of each asymmetric distortion stage is substantially equal to the magnitude of the negative and positive saturation limits respectively of adjacent asymmetric distortion stages of adjacent frequency bands so as to produce an audio output signal that demonstrates a smooth transition from linear behaviour to the production of crossover-like artifacts, with a reduction of intermodulation distortion.

13. A multiband nonlinear processor according to claim 9 wherein one or both of the positive and negative saturation limits of each asymmetric distortion stage is different to the magnitude of the negative and positive saturation limits respectively of adjacent asymmetric distortion stages of adjacent frequency bands so as to produce an audio output signal that demonstrates a smooth transition from linear behaviour to the production of crossover-like artifacts, with a reduction of intermodulation distortion, and with a spectrum which includes even harmonics of the input frequencies of the audio input signal.

14. A multiband nonlinear processor according to claim 9 wherein the symmetric distortion stages each comprise a low-pass filter to provide a reduction of harmonic energy when nonlinearly limiting the distorted signals from the asymmetric distortion stages.

15. A multiband nonlinear processor according to claim 9 further comprising cross-coupling between the frequency bands before the distortion stages to allow the controlled increase of intermodulation distortion.

16. A multiband nonlinear processor according to claim 9 wherein the audio input signal is from an electric or electronic musical instrument.

17. A nonlinear audio distortion circuit for distorting audio signals from musical instruments, comprising:
an input stage that is arranged to split an audio input signal into two signal paths;
a pair of asymmetric distortion stages, one in each signal path, with non-equal negative and positive saturation limits, so as to produce opposite polarity mean signal levels at their outputs in each signal path, and which produce a smooth transition from linear to nonlinear behaviour;
a pair of AC-coupled symmetric distortion stages, one in each signal path, following the asymmetric distortion stages; and
an output stage that is arranged to add the two nonlinearly distorted signals from the symmetric distortion stages to generate an audio output signal that demonstrates a smooth transition from linear behaviour to the production of crossover-like artifacts.

18. A nonlinear audio distortion circuit according to claim 17 wherein the saturation limits in the two asymmetric distortion stages are the opposite of each other so as to produce an audio output signal at the output stage that demonstrates a smooth transition from linear behaviour to the production of crossover-like artefacts.

19. A nonlinear audio distortion circuit according to claim 17 wherein the saturation limits of the two asymmetric distortion stages are different to each other so as to produce a final audio output signal that demonstrates a smooth transition from linear behaviour to the production of crossover-like artefacts, with a spectrum which includes even harmonics of the input frequencies of the audio input signal.

20. A nonlinear audio distortion circuit according to claim 17 wherein the symmetric distortion stages each comprise an amplifier with a feedback loop that is arranged to nonlinearly limit the signal of its signal path and a low-pass filter in the feedback loop that is arranged to provide a reduction of harmonic energy when limiting the signal.
